(19) United States
(12) Patent Application Publication
(10) Pub. No.: US 2026/0195022 A1
(43) Pub. Date: Jul. 9, 2026

(54) IMAGE DISPLAY SYSTEM AND NON-TRANSITORY COMPUTER-READABLE RECORDING MEDIUM FOR RECORDING IMAGE DISPLAY PROGRAM

(71) Applicant: AWL, Inc., Tokyo (JP)

(72) Inventors: Hiroshi FUJIMURA, Tokyo (JP); Yasuhiro TSUCHIDA, Tokyo (JP); Naman MEHTA, Tokyo (JP); Tian YU, Tokyo (JP); Fadoua GHOURABI, Tokyo (JP); Joo Ann WOO, Tokyo (JP); Harsh SILOIYA, Tokyo (JP); Zheng LIU, Tokyo (JP); Wasu WASUSATEIN, Tokyo (JP); Kittinun AUKKAPINYO, Tokyo (JP); Intisar MD CHOWDHURY, Tokyo (JP); Kriti AGARWAL, Tokyo (JP); Yoshinao SHIBAGAKI, Tokyo (JP); Baskara ., Tokyo (JP)

(73) Assignee: AWL, Inc., Tokyo (JP)

(21) Appl. No.: 19/431,358

(22) Filed: Dec. 23, 2025

(30) Foreign Application Priority Data
Jan. 6, 2025 (JP) 2025-001868

(51) Int. Cl. G06F 3/0482; G06F 3/14

(52) U.S. Cl. CPC G06F 3/0482; G06F 3/14

(57) ABSTRACT

The image display system includes a primary selection circuitry to perform, on an edge device side, a primary selection of a frame image, which is detecting a user's desired viewing target from frame images input from a camera according to a rough selection criterion, an edge device side transmission circuitry to transmit the frame image selected by the primary selection circuitry to a cloud side, a cloud side storage circuitry to store, on the cloud side, the frame image transmitted from the edge device, a secondary selection circuitry to perform, on the cloud side, a secondary selection of a frame image, which is selecting a frame image, in which the user's desired viewing target appears, according to a detailed selection criterion, and an image display control circuitry to perform, on the cloud side, control such that an image, in which the user's desired viewing target appears, is displayed.

### CROSS-REFERENCE TO RELATED APPLICATION

This application is based on and claims the benefit of priority of the prior Japanese Patent Application No. 2025-001868, filed on Jan. 6, 2025, the entire contents of which are incorporated herein by reference.

### BACKGROUND OF THE INVENTION

### 1. Field of the Invention

The present invention relates to an image display system, and a non-transitory computer-readable recording medium for recording an image display program.

### 2. Description of the Related Art

Conventionally, by using a video management system (VMS), an image captured by a camera such as a monitoring camera installed in a facility such as a store can be transferred to a server on a cloud and stored, and a user such as an operator of a management department can view the image on a display device at a remote location.

In addition, a system is known in which an image captured by a camera installed in a facility such as a store is analyzed using a learned object detection algorithm (firmware) and a learned object recognition algorithm (firmware) by a device (so-called edge device) disposed on the facility in which the camera is installed (for example, see Japanese Unexamined Patent Application Publication No. 2018-88157).

As described above, when the VMS is used, the user can view an image captured by a camera such as a monitoring camera installed in a facility from a display device at a remote location. However, the user wants to view not all of the images captured by the camera but a part of the images (for example, a moving image of a customer who acts suspiciously). Nevertheless, if all the images captured by the camera are transferred to and stored in the server on the cloud, the amount of communication between the edge device and the server (cloud side) increases. Therefore, it is conceivable that the image analysis system on the edge device side as described in the Japanese Unexamined Patent Application Publication No. 2018-88157 detects a user's desired viewing target, selects only a frame image in which the user's desired viewing target appears, and transfers the frame image to a server on a cloud.

However, due to the vulnerability of computer resources in the edge device, it is difficult to perform the detection processing of the user's desired viewing target (the selection processing of the frame image in which the user's desired viewing target appears) only by the edge device.

### BRIEF SUMMARY OF THE INVENTION

An object of the present invention is to solve the problems described above, and to provide an image display system, and a non-transitory computer-readable recording medium for recording an image display program that make it possible to suppress the amount of communication between an edge device side and a cloud side and suppress a processing load in the edge device.

According to a first aspect of the present invention, this object is achieved by an image display system comprising: a primary selection circuitry configured to perform, on an edge device side, a primary selection of a frame image, which is a process of detecting a user's desired viewing target from frame images input from a camera in accordance with a rough selection criterion to select a frame image in which the user's desired viewing target is likely to appear; an edge device side transmission circuitry configured to transmit the frame image selected by the primary selection circuitry or image information, which is information corresponding to the frame image selected by the primary selection circuitry, from the edge device side to a cloud side; a cloud side storage circuitry configured to store, on the cloud side, the frame image or the image information transmitted by the edge device side transmission circuitry; a secondary selection circuitry configured to perform, on the cloud side, a secondary selection of a frame image, which is a process of selecting a frame image, in which the user's desired viewing target appears, in accordance with a detailed selection criterion by using the frame images or the image information stored in the cloud side storage circuitry; and an image display control circuitry configured to perform, on the cloud side, control such that an image, in which the user's desired viewing target appears, is displayed on a display on the cloud side by using the frame image selected by the secondary selection in the secondary selection circuitry or time information corresponding to the frame image selected by the secondary selection.

In the above configuration, unlike the conventional image display system using the VMS, not all the images captured by the camera but only the frame image selected by the primary selection circuitry or the image information corresponding to the frame image selected by the primary selection circuitry is transmitted from the edge device side to the cloud side. Accordingly, the amount of communication between the edge device side and the cloud side can be suppressed. In addition, in the selection process of the frame image in which the user's desired viewing target appears, only the process of detecting the user's desired viewing target from frame images input from the camera according to the rough selection criterion (primary selection of the frame image) is performed on the edge device side, and the process of selecting the frame image in which the user's desired viewing target appears according to the detailed selection criterion (secondary selection of the frame image) is performed on the cloud side. Thus, it is possible to accurately select an image in which the user's desired viewing target appears and display the image on the display on the cloud side while suppressing a processing load on the edge device.

According to a second aspect of the present invention, the above object is achieved by a non-transitory computer-readable recording medium for recording an image display program to cause a computer to perform a process including the steps of: performing, on an edge device side, a primary selection of a frame image, which is a process of detecting a user's desired viewing target from frame images input from a camera in accordance with a rough selection criterion to select a frame image in which the user's desired viewing target is likely to appear; transmitting the frame image selected by the primary selection or image information, which is information corresponding to the frame image selected by the primary selection, from the edge device side to a cloud side; storing, on the cloud side, the frame image or the image information transmitted from the edge device side; performing, on the cloud side, a secondary selection of a frame image, which is a process of selecting a frame image, in which the user's desired viewing target appears, in accordance with a detailed selection criterion by using the frame image or the image information stored on the cloud side; and performing, on the cloud side, control such that an image, in which the user's desired viewing target appears, is displayed on a display on the cloud side by using the frame image selected by the secondary selection or time information corresponding to the frame image selected by the secondary selection.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that the drawings are shown for the purpose of illustrating the technical concepts of the present invention or embodiments thereof, wherein:

FIG. 1 is a schematic block diagram showing an outline of an image display system according to a first embodiment of the present invention;

FIG. 2 is a schematic block diagram showing a hardware configuration of an edge device in FIG. 1;

FIG. 3 is a schematic block diagram showing a hardware configuration of a cloud server in FIG. 1;

FIG. 4 is a schematic block diagram showing a hardware configuration of a client in FIG. 1;

FIG. 5 is a schematic functional block diagram of the image display system according to the first embodiment;

FIG. 6 is a flowchart illustrating an example of a processing performed by the image display system according to the first embodiment;

FIG. 7 is a flowchart illustrating an example of a processing performed by the image display system according to the first embodiment;

FIG. 8 is a flowchart illustrating an example of a display control procedure performed by the image display system according to the first embodiment;

FIG. 9 is a diagram illustrating an example of a screen displayed on a display of the client.

FIG. 10 is a diagram illustrating an example of another screen displayed on the display of the client.

FIG. 11 is a schematic functional block diagram of the image display system according to the second embodiment;

FIG. 12 is a flowchart illustrating an example of a procedure performed by the image display system according to the second embodiment;

FIG. 13 is a flowchart illustrating an example of a procedure performed by the image display system according to the second embodiment;

FIG. 14 is a flowchart illustrating an example of a procedure performed by a selection operation circuitry and an image display control circuitry in the image display system according to the second embodiment;

FIG. 15 is a schematic functional block diagram of the image display system according to the third embodiment;

FIG. 16 is a schematic functional block diagram of the image display system according to the fourth embodiment;

FIG. 17 is a flowchart illustrating an example of a procedure performed by the image display system according to the fourth embodiment;

FIG. 18 is a flowchart illustrating an example of a procedure performed by the image display system according to the fourth embodiment; and

FIG. 19 is a flowchart illustrating an example of a procedure performed by a selection operation circuitry and an image display control circuitry in the image display system according to the fourth embodiment.

### DETAILED DESCRIPTION OF THE INVENTION

The present disclosure will be specifically described with reference to the drawings illustrating embodiments thereof. In the following embodiments, an image display system of the present disclosure will be described.

### First Embodiment

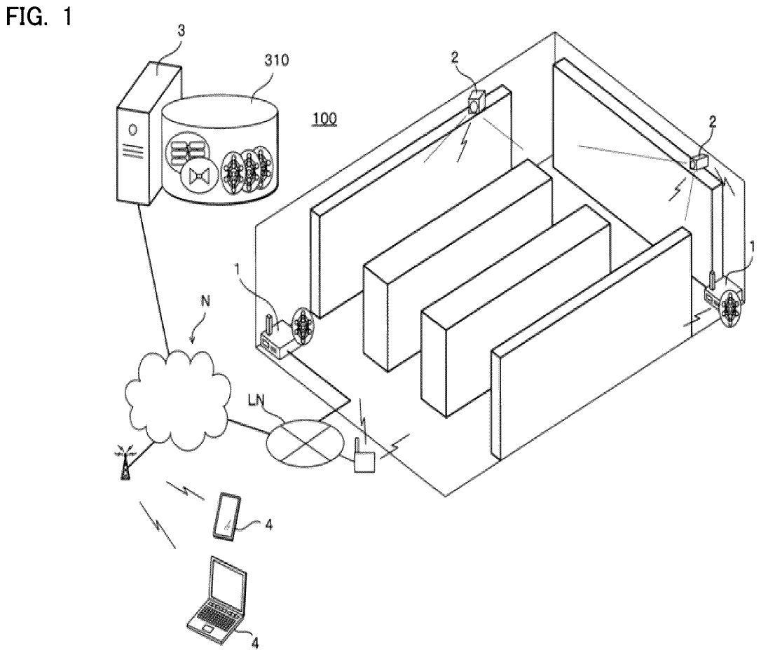

FIG. 1 is a schematic diagram of an image display system 100 according to a first embodiment. The image display system 100 includes a camera 2 installed in a target space such as a store, an edge device 1 connected to the camera 2, a cloud server 3 capable of communicative connection to the edge device 1, and a client 4 capable of communicative connection to the cloud server 3. A plurality of edge devices 1 and a plurality of cameras 2 may be installed in the same space.

The camera 2 outputs image information using an image element corresponding to visible light and/or near-infrared light. The camera 2 outputs image information in time series at a rate of several fps to several tens of fps. The camera 2 is installed so as to look down a space, in which the camera 2 is installed, from a high place such as a ceiling or a shelf of the space. The camera 2 may be of a type attached to a ceiling and may include a 360-degree space in an angle of view. The camera 2 sequentially transmits image information to the edge device 1 via a local network LN.

The camera 2 and the edge device 1 can be communicatively connected to each other via a wireless or wired local network LN. The local network LN may be a wired local area network (LAN) or a wireless network such as WiFi and Bluetooth.

The edge device 1 can be communicatively connected to the cloud server 3 via the network N. The network N is a wired or wireless communication network that may include a public communication network, a dedicated line, or a carrier network. The client 4 can be communicatively connected to the cloud server 3 and the edge device 1 via the network N.

The cloud server 3 holds pre-trained learning models to be used in respective processes to be selectively performed by the edge device 1 and the cloud server 3 in a database 310. The database 310 may include pre-trained learning models provided from an external service outside the image display system 100. The cloud server 3 reads, from the database 310, respective pre-trained learning models corresponding to respective objects to be detected by respective processes to be performed by the edge device 1 and the cloud server 3, and deploys the pre-trained learning models to the edge device 1 and the cloud server 3.

The image display system 100 according to the first example embodiment extracts a feature amount in an image captured by the camera 2 installed in a target space, detects an object such as a person from the image based on the feature amount, recognizes an attribute of the detected object, and outputs a recognition result. The image display system 100 is a system that enables the client 4 to automatically display an image in which the user's desired object (viewing target) appears.

The image display system 100 according to the first embodiment is a system in which a user can perform an operation of selecting which attribute of a person or an object is to be detected from an image. In addition, in the image display system 100 of the first embodiment, it is possible to suppress the amount of communication between the edge device 1 and the cloud server 3, and to suppress the processing load on the edge device 1 by sharing the processing between the edge device 1 and the cloud server 3.

Hereinafter, configurations of the edge device 1, the cloud server 3, and the client 4 for realizing this image display system 100 and details of processing executed by each of them will be described.

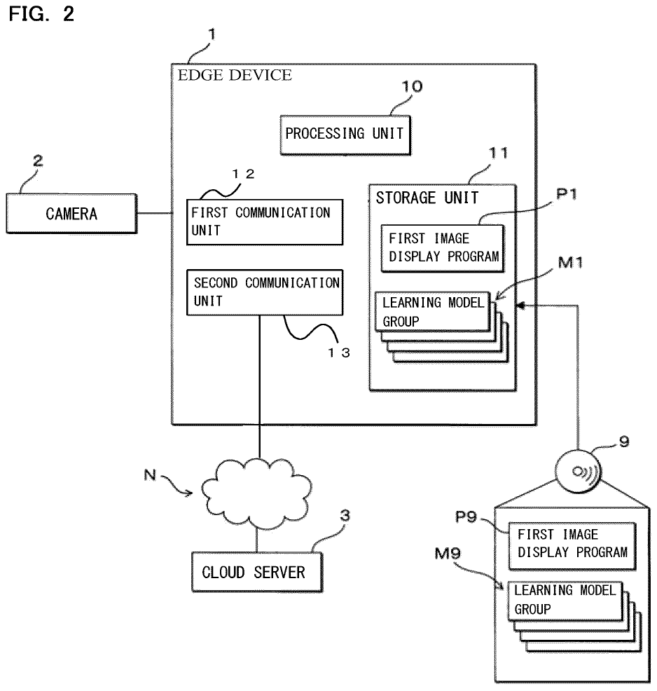

FIG. 2 is a block diagram illustrating a configuration of the edge device 1. The edge device 1 is a box-type device that can be disposed together with the camera 2 in the target space. The edge device 1 includes a processing unit 10, a storage unit 11, a first communication unit 12, and a second communication unit 13.

The processing unit 10 includes one or more processors such as a central processing unit (CPU), a micro-processing unit (MPU), a graphics processing unit (GPU), or a neutral processing unit (NPU). The processing unit 10 includes a memory that is a temporary storage medium such as a static random access memory (SRAM) or a dynamic random access memory (DRAM). The processing unit 10 includes a timer, and can acquire time information at each time point from the timer. The processing unit 10 may be configured as one piece of hardware (SoC: system on a chip) in which a processor, a memory, the storage unit 11, the first communication unit 12, and the second communication unit 13 are integrated. The specifications of respective processing units 10 in the image display system 100 may be the same or different among the edge devices 1.

The processing unit 10 reads the first image display program P1 stored in the storage unit 11 into the memory and executes the first image display program P1 to cause the processor to execute various processes to be described later and function as the edge device 1 of the present disclosure.

The storage unit 11 is a relatively large-capacity non-transitory storage medium such as a hard disk or a flash memory. A part of the storage unit 11 may be removable.

The storage unit 11 stores a program (program product) necessary for the processing unit 10 to perform processing, a processing result of the processing unit 10, and setting information for reference. The setting information includes an identifier of the edge device 1, identification data of the camera 2 to be connected, and the like. The program product includes an OS (operating system) program, a first image display program P1 operating on the OS in the edge device 1, and a learning model group M1. The learning model group M1 will be described in detail later.

The first image display program P1 and the learning model group M1 stored in the storage unit 11 may be the first image display program P9 and the learning model group M9 stored in the computer-readable non-transitory storage medium 9 and be read from the computer-readable storage medium 9 to be stored in the storage unit 11 by the processing unit 10, or may be stored in the storage unit 11 prior to shipment of the edge device 1. The first image display program P1 or the learning model group M1 stored in the storage unit 11 may be downloaded by the processing unit 10 from the database 310 of the cloud server 3 or from another download server via the second communication unit 13.

The storage unit 11 stores image information that can be acquired from the connected camera 2 in time series in association with time information. The image information may be a frame image or a moving image. The storage unit 11 stores only image information in which a user's desired object (viewing target) is detected, as a result of processing of the processing unit 10 to be described later. The storage unit 11 may continue to overwrite and store data according to a FIFO (First In First Out) method within a range corresponding to the size of the capacity. The storage unit 11 may store text information describing the detected object, text information indicating an attribute of the detected object, and the like in association with time information.

The first communication unit 12 is a communication device that realizes communication via a local network LN installed in the target space. The first communication unit 12 may be a LAN network card or a controller area network (CAN) communication device. The first communication unit 12 may be a communication device compatible with a wireless network such as WiFi or Bluetooth. The first communication unit 12 may include a plurality of communication devices corresponding to various types of cameras 2. The first communication unit 12 may include an interface such as a universal serial bus (USB) to be connected to the camera 2. The first communication unit 12 can be replaced with an interface to be connected to the camera 2 via a coaxial cable or another serial bus. The processing unit 10 acquires image information from the camera 2 via the local network LN by the first communication unit 12. The first communication unit 12 may be the same device as the second communication unit 13 to be described later.

The second communication unit 13 is a communication device that realizes communication via the external network N. The second communication unit 13 may be a wired LAN network card or a communication device that realizes carrier communication via a carrier network. The second communication unit 13 may be a communication device compatible with a wireless network such as WiFi or Bluetooth. The second communication unit 13 may support secure communication such as SSL with the cloud server 3. The second communication unit 13 may be an interface for realizing communication connection with the cloud server 3 via a dedicated line.

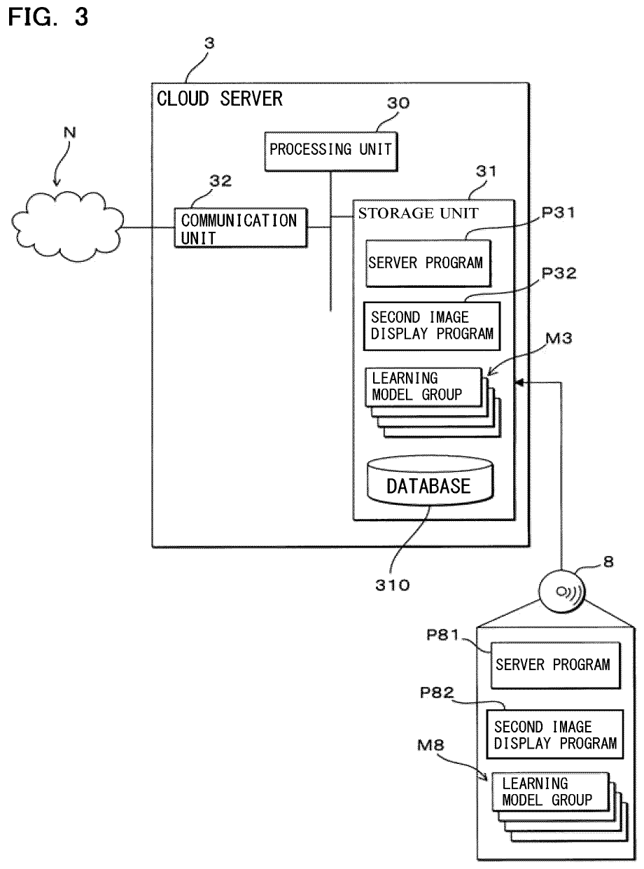

FIG. 3 is a block diagram illustrating a configuration of the cloud server 3. The cloud server 3 may be configured by one server computer or may be configured to distribute processing among a plurality of server computers. The cloud server 3 comprises a processing unit 30, a storage unit 31, and a communication unit 32.

The processing unit 30 includes one or more processors such as CPUs, MPUs, GPUs, and NPUs. The processing unit 30 includes a memory that is a temporary storage medium such as an SRAM or a DRAM.

The storage unit 31 is a relatively large-capacity non-transitory storage medium such as a hard disk or a flash memory. The storage unit 31 stores a program (program product) and setting information necessary for the processing unit 30 to execute processing to be described later.

The program product stored in the storage unit 31 includes a server program P31. The server program P31 includes a module which functions as a data server that reads a model group stored in the database 310 and transmits the model group to the edge device 1. The server program P31 includes a module that functions as a Web server, and can output a result of processing executed by the cloud server 3 to the client 4 by a Web page.

The program product stored in the storage unit 31 includes a second image display program P32 operating on the cloud server 3 and a learning model group M3. The second image display program P32 is a program that causes the processing unit 30 to execute processing in cooperation with the processing based on the first image display program P1 in the edge device 1. The learning model group M3 is selected from pre-trained learning models in the database 310 and stored into the storage unit 31. The second image display program P32 and the learning model group M3 will be described in detail later.

The server program P31 and the second image display program P32 stored in the storage unit 31 may be obtained in a way that the processing unit 30 reads the server program P81 and the second image display program P82 stored in the computer-readable non-transitory storage medium 8 to store the server program P81 and the second image display program P82 into the storage unit 31. The learning model group M3 may also be obtained in a way that the processing unit 30 reads the learning model group M8 stored in the non-transitory storage medium 8 to store the learning model group M8 into the storage unit 31. The server program P31 and the second image display program P32 stored in the storage unit 31 may be downloaded by the processing unit 30 from another download server via the communication unit 32.

The setting information stored in the storage unit 31 includes data showing a correspondence relationship between data or a name for identifying a space, in which the edge device 1 is installed, and identification data of the edge device 1. The cloud server 3 may store identification data of an edge device 1 or a space for which a request of a user is permitted in the storage unit 31 as a white list in association with account data of the user in order to execute processing on a plurality of target spaces simultaneously. Thus, when the user designates the name of a space and designates which object is to be detected in an image captured by the camera 2 installed in the space, the cloud server 3 can specify the target edge device 1.

The storage unit 31 stores image information captured by the camera 2 and selected by the primary selection or the secondary selection. The image information may be a frame image, frame images continuous in time series, or moving images divided as a file in a predetermined time unit.

The database 310 may be constructed in the storage unit 31 or may be constructed in an external storage device. A part of the database 310 may include the model providing service used on the Web communicatively connected via the network N as described above. The database 310 holds a learning model group used in processes executed by the edge device 1 and the cloud server 3. The learning model group includes, for example, detection learning models such as a person detector, a head detector, a face detector, an animal detector, and a specific device detector. The learning model group further includes a recognition learning model such as an age recognizer, a glasses wearing recognizer, a hat wearing recognizer, a face orientation recognizer, or a posture recognizer. The learning model group includes a large language model (LLM), a small language model (SLM), a vision language model (VLM), and the like.

The communication unit 32 is a communication device that realizes communication connection with the client 4 and the edge device 1 via the network N.

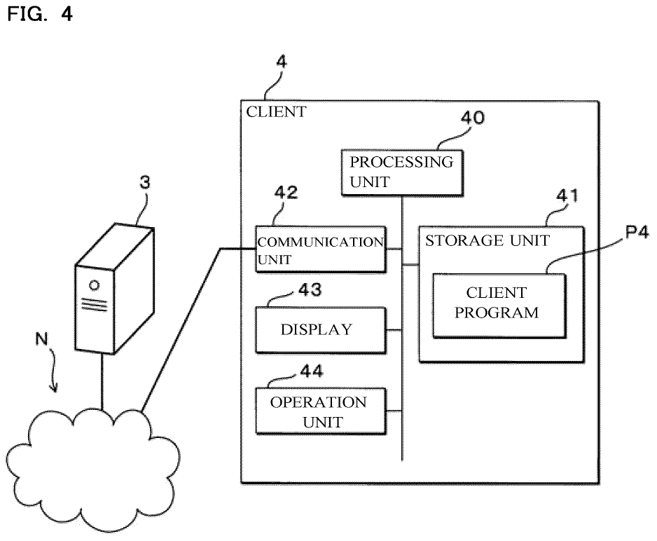

FIG. 4 is a block diagram showing the configuration of the client 4. The client 4 is a personal computer, a smartphone, or a tablet terminal. The client 4 may be used by a manager of a space in which the camera 2 is installed, or may be used by an operator of a management company of the cloud server 3.

The client 4 comprises a processing unit 40, a storage unit 41, a communication unit 42, a display 43, and an operation unit 44. The processing unit 40 includes one or more processors such as a CPU, an MPU, a GPU, and an NPU. The processing unit 40 includes a memory that is a temporary storage medium such as an SRAM or a DRAM.

The storage unit 41 is a memory of a non-transitory storage medium such as a hard disk or a flash memory. The storage unit 41 stores a module to use the function of the data server to be provided by the cloud server 3 and a client program P4 to function as the Web client. The client program P4 is, for example, a Web browser program. The client program P4 is a program that causes the processing unit 40 to execute a process of displaying various data including an image provided from the cloud server 3 on the screen.

The communication unit 42 is a communication device that realizes communication connection with the cloud server 3 via the network N. The communication unit 42 may be a communication device that realizes communication connection with the cloud server 3 via a dedicated line. The communication unit 42 may be a communication device that realizes direct communication connection with the second communication unit 13 of the edge device 1 via a wireless communication medium, a USB cable, or the like.

The display 43 is a display such as a liquid crystal display or an organic electro luminescence (EL) display. The display 43 displays a Web page including characters and images by processing of the processing unit 40 according to the client program P4. The display 43 may be a display with a built-in touch panel.

The operation unit 44 is a user interface such as a keyboard or a pointing device that receives an operation from a user or an operator. The operation unit 44 may be a touch panel built into the display 43 or a physical button. The operation unit 44 may be a voice input unit and receive an operation by voice using a voice recognition function. The operation unit 44 can notify the processing unit 40 of operations by a user or an operator.

In the image display system 100 configured as described above, the edge device 1 and the cloud server 3 perform distributed processing for an image captured by the camera 2 in each space, and an image in which an object appears is displayed on the client 4 so that the user can view the image.

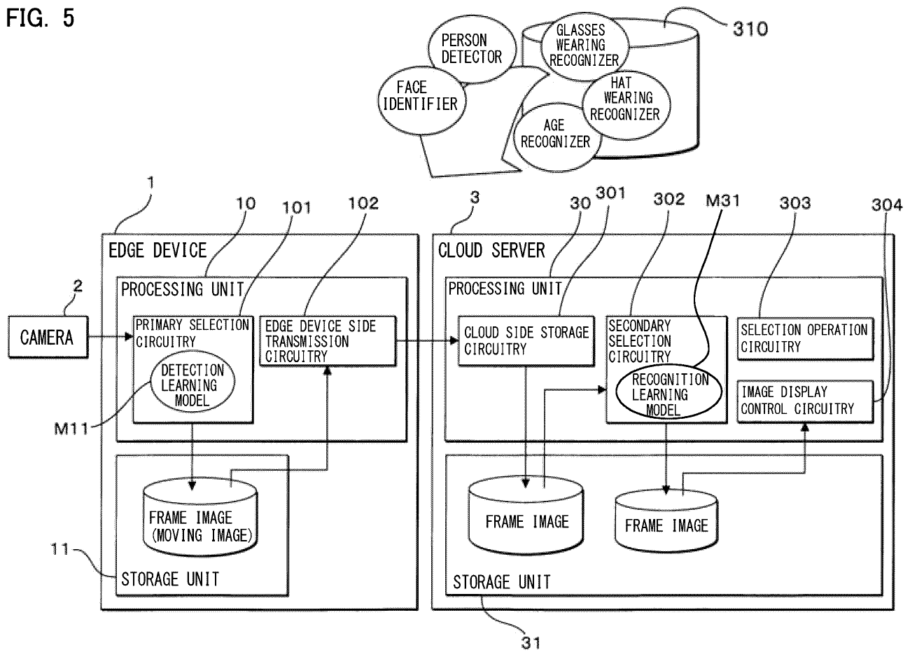

FIG. 5 is a functional block diagram of the image display system 100. In the image display system 100, the functions illustrated in FIG. 5 are shared and exhibited by the edge device 1 and the cloud server 3 according to the first image display program P1 of the edge device 1 and the second image display program P32 of the cloud server 3. In the image display system 100, the processing unit 10 of the edge device 1 functions as the primary selection circuitry 101 and the edge device side transmission circuitry 102, and the processing unit 30 of the cloud server 3 functions as the cloud side storage circuitry 301, the secondary selection circuitry 302, the selection operation circuitry 303, and the image display control circuitry 304.

In the first embodiment, the primary selection circuitry 101 receives a frame image obtained by the camera 2 through the first communication unit 12, and selects a frame image in which a user's desired object is likely to appear using the detection learning model M11. The detection learning model M11 is selected from detection learning models such as a person detector, a head detector, a face detector, an animal detector, and a specific device detector, which are stored in the database 310, according to a detection target object set for each space, and is stored in the storage unit 11. Further, an object detection process using the detection learning model M11 is deployed in the edge device 1. The primary selection circuitry 101 inputs a frame image from the camera 2 into the detection learning model M11, and obtains a detection result (coordinate data of a region in which an object is captured, and accuracy) output from the detection learning model M11. The primary selection circuitry 101 selects a target frame image in a case where it can be determined that an object appears based on the detection result obtained from the detection learning model M11. The primary selection circuitry 101 may store the selected frame image in the storage unit 11 and discard the unselected frame image. The primary selection circuitry 101 stores a moving image for a predetermined time before and after the selected frame image in the storage unit 11 as image information. When frame images continuous in time series are selected, the primary selection circuitry 101 may store them in the storage unit 11 as a moving image. The processing unit 10 may improve the detection accuracy of the detection learning model M11 by referring to the size or the like of the image included in the configuration data. When the processing unit 10 cannot detect an object such as a person as the primary selection circuitry 101, the processing unit 10 ends the processing on the target frame image, does not execute the subsequent processing, and executes the processing on the next frame image.

As a result of the primary selection, the primary selection circuitry 101 may store text information in association with a frame image in which an object is likely to appear. For example, when the detection target of the detection learning model M11 is a person, a head, a face, an animal, or a specific device, the primary selection circuitry 101 may store “person”, “head”, “face”, “animal”, or “specific device” as text information describing the detected object.

In the first embodiment, the edge device side transmission circuitry 102 transmits the frame image selected by the function of the primary selection circuitry 101 to the cloud server 3 by the second communication unit 13. The edge device side transmission circuitry 102 may transmit a moving image composed of previous and subsequent frames including the frame image to the cloud server 3, or may transmit text information (image information) including time information corresponding to the frame image to the cloud server 3. The time information is information indicating any one of a time, a time stamp, and an elapsed time or count from a specific time which are corresponding to a frame image. In a case where text information is saved in association with the frame image by the primary selection circuitry 101, the edge device side transmission circuitry 102 preferably transmits also the text information to the cloud server 3.

The cloud side storage circuitry 301 stores (saves) the frame image or the image information transmitted from the edge device 1 by the edge device side transmission circuitry 102 in the storage unit 31. The frame image or the image information to be stored in the storage unit 31 is the frame image or the image information selected by the edge device 1. When the cloud server 3 receives not only the frame image but also the time information or the text information from the edge device 1, the cloud side storage circuitry 301 also stores (saves) the time information or the text information (image information) in the storage unit 31 in association with the identification data of the edge device 1, the identification data of the camera 2, and the like.

The secondary selection circuitry 302 further selects frame images showing a user's desired object from frame images or image information stored (saved) in the storage unit 31 by the cloud side storage circuitry 301 in accordance with detailed selection criteria. The detailed selection criteria include a criterion for an attribute for determining that an object is an object desired by the user with respect to frame images in which the object is detected by the primary selection circuitry 101. The detailed selection criterion is, for example, a criterion for an attribute of a person in a case where it is detected that the person appears in the primary selection circuitry 101. This criterion is, for example, a selection criterion that, when a person is detected in the primary selection circuitry 101, a frame image showing a person in a specific posture, a person of a specific age, or the like is selected in the secondary selection circuitry 302.

Another selection criterion may be used as long as the selection criterion for the secondary selection circuitry 302 is more detailed than the selection criterion for the primary selection circuitry 101. The secondary selection circuitry 302 is used for increasing the probability that an object detected by the primary selection circuitry 101 of the edge device 1 is an object desired by the user. The detailed selection criterion in the secondary selection circuitry 302 is, for example, a criterion according to which the secondary selection circuitry 302 can reliably determine that an object appeared in a frame image is a person, in the case where the primary selection circuitry 101 detects that an object as large as a person appears in the frame image and the person is likely to appear in the frame image.

For example, the secondary selection circuitry 302 recognizes the attribute of the detected object using the recognition learning model M31 in order to determine that an object is the user's desired object. The recognition learning model M31 is selected from recognizers such as an age recognizer, a glasses wearing recognizer, a hat wearing recognizer, a face direction recognizer, a posture recognizer, and a detector of a person wearing clothes of a specific color (for example, yellow clothes) stored in the database 310 according to an object of a detection target set for each space, that is, a user's desired viewing target. Further, an object recognition process using the recognition learning model M31 is deployed in the cloud server 3, and the processing unit 30 executes the recognition process as the second selection circuitry 302. The secondary selection circuitry 302 inputs the frame image saved by the cloud side storage circuitry 301 to the recognition learning model M31, and stores the frame image in the storage unit 31 only in a case where the secondary selection circuitry 302 decides that an object having a user's desired attribute appears in the input frame image according to a recognition result output from the recognition learning model M31.

Instead of or in addition to the recognition learning model M31, a detection model for detecting an object with higher accuracy may be used. For example, in the primary selection circuitry 101, the detection learning model M11 may be used to detect on the edge device 1 side whether or not an object as large as a person appears in the frame image, and the secondary selection circuitry 302 may use the detection learning model on the secondary side to detect with high accuracy whether or not a person appears in the frame image. The processing unit 30 may input the frame images to the learning model for detection on the secondary side, narrow down the frame images to frame images in which the object is more likely to appear based on the detection result output from the model, and store the frame images in the storage unit 31.

When text information corresponding to a description of a criterion for selecting a frame image is stored in association with the frame image, the secondary selection circuitry 302 may determine whether a user's desired viewing target (object) appears in the frame image with reference to the text information. In this case, the text information is used as supplementary information.

The secondary selection circuitry 302 may delete frame images other than the frame images stored by the processing of the secondary selection circuitry 302 among the frame images stored (saved) by the cloud side storage circuitry 301.

The selection operation circuitry 303 performs control such that a selection operation of a frame image to be displayed on the display 43 of the client 4 connected to the cloud server 3 among the frame images narrowed down by the secondary selection of the secondary selection circuitry 302 is received from the operation unit 44 of the client 4. The processing unit 30 receives a selection operation on a Web page displayed on the client 4 based on a Web server module included in the server program P31.

The image display control circuitry 304 performs control to display the frame images narrowed down by the secondary selection of the secondary selection circuitry 302 on the display 43 of the client 4 connected to the cloud server 3. Based on the Web server module included in the server program P31, the processing unit 30 performs control as the image display control circuitry 304 so that the frame images narrowed down by the secondary selection are included in the Web page displayed on the client 4.

As described above, in the image display system 100 exhibiting each function, the edge device 1 detects whether or not an object appears in a frame image captured by the camera 2 according to a rough selection criterion to perform primary selection. The edge device 1 primarily selects a frame image in which an object is detected, and transmits the frame image to the cloud server 3. The cloud server 3 performs secondary selection of selecting a frame image in which an object appears in accordance with a detailed selection criterion for the primarily selected frame image. The cloud server 3 stores the selected frame image in the storage unit 31 so as to be viewable from the client 4.

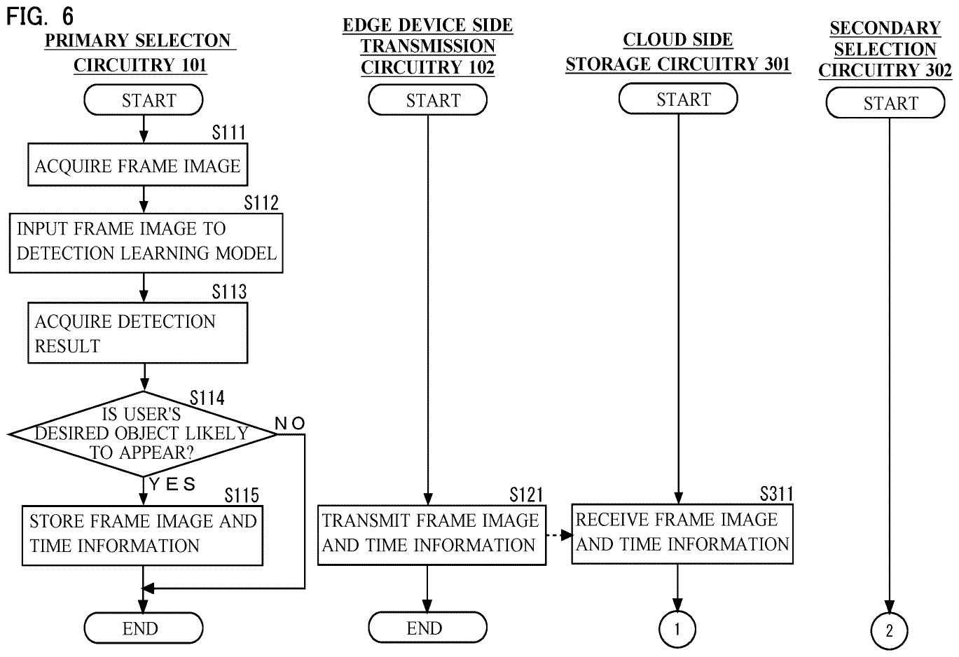

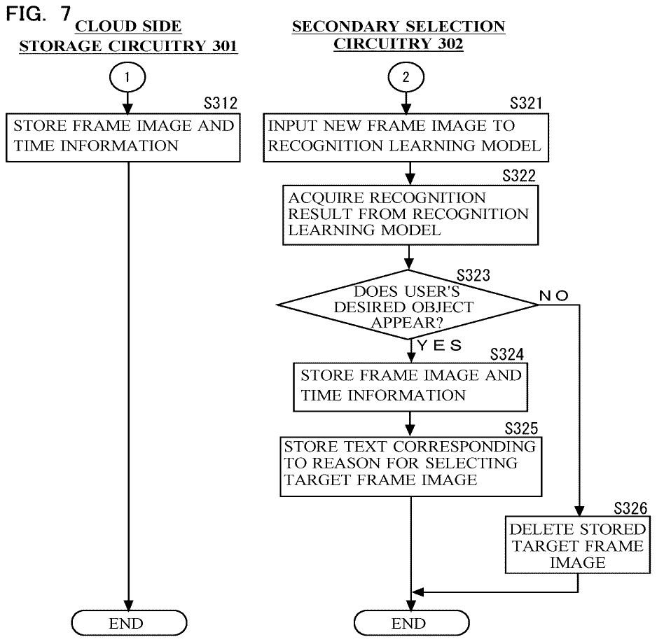

A procedure of each function (each circuitry) of the image display system 100 illustrated in FIG. 5 will be described with reference to a flowchart. FIGS. 6 and 7 are flowcharts illustrating an example of a processing procedure in the image display system 100.

The processing unit 10 of the edge device 1 acquires a frame image from the camera 2 by the function of the primary selection circuitry 101 (step S111). The processing unit 10 inputs the acquired frame image to the detection learning model M11 (step S112) to acquire a detection result (step S113). Based on the detection result, the processing unit 10 determines whether or not a user's desired object is likely to appear in the frame image acquired in step S111 (step S114).

When determining that the user's desired object is likely to appear in the frame image (S114: YES), the processing unit 10 stores the frame image in the storage unit 11 in association with time information indicating a time at which the frame image is captured (step S115). The primary selection circuitry 101 of the processing unit 10 ends the processing on the acquired frame image. In step S115, the processing unit 10 may also store text information (for example, “person (human)” or the like) indicating the detection target of the detection learning model M11 in the storage unit 11 in association with the frame image.

In step S114, when the processing unit 10 determines that the user's desired object is not likely to appear in the frame image (S114: NO), the processing unit 10 ends the processing on the acquired frame image. The frame image acquired in step S111 may not be stored in the storage unit 11.

When a new frame image is stored in the storage unit 11, the processing unit 10 of the edge device 1 transmits the frame image and the time information corresponding to the frame image to the cloud server 3 by the function of the edge device side transmission circuitry 102 (step S121). In step S121, the processing unit 10 transmits also the identification data of the edge device 1 to the cloud server 3. Accordingly, the cloud server 3 corresponding to the plurality of spaces can specify in which space the frame image is captured.

On the cloud server 3 side, the processing unit 30 receives the frame image and the time information transmitted from the edge device 1 by the function of the cloud side storage circuitry 301 (step S311), stores (saves) the frame image and the time information in the storage unit 31 (step S312), and ends the reception and storage (saving) processing. In step S312, the processing unit 30 stores (saves) the identification data of the edge device 1, which is received together with the frame image and the time information, in association with the frame image and the time information.

When a new frame image in which a user's desired object appears is stored in the storage unit 31 by the function of the secondary selection circuitry 302, the processing unit 30 inputs the new frame image to the recognition learning model M31 (step S321). The processing unit 30 acquires the recognition result (whether or not the attribute is satisfied) from the recognition learning model M31 (step S322), and determines whether or not the user's desired object appears in the frame image input to the recognition learning model M31 according to the detailed selection criterion (step S323). In step S323, when text information is stored in association with the frame image, the processing unit 30 may also refer to the text information for the determination.

When it is determined that the user's desired object appears in the frame image according to the detailed selection criterion (S323: YES), the processing unit 30 stores the frame image and the time information corresponding to the frame image in the storage unit 31 in association with each other (step S324). When the processing unit 30 selects frame images continuous in time series by the function of the secondary selection circuitry 302, the processing unit 30 may store the frame images as one moving image in step S324. In step S324, the processing unit 30 may acquire from the edge device 1 a moving image for a predetermined time before and after the frame image selected by the secondary selection circuitry 302 to store the moving image in the storage unit 31. In step S324, the processing unit 30 also stores in the storage unit 31 the identification data of the edge device 1 which is saved in association with the frame image. The processing unit 30 stores the text corresponding to the attribute recognized by the recognition learning model M31 used for the new frame image, that is, the text corresponding to the reason (attribute) for selecting the target frame image, in association with the frame image and the time information (step S325). In step S325, the processing unit 30 stores, for example, text information indicating the attribute of the object recognized by the recognition learning model M31 used in step S321. Because the process of step S325 means storing texts for search, it is unnecessary when text-based search is not accepted in the image display system 100.

When it is determined that the user's desired object does not appear in the frame image (S323: NO), the processing unit 30 deletes the target frame image stored in the storage unit 31 by the cloud side storage circuitry 301 from the storage unit 31 (step S326).

According to the procedure illustrated in FIGS. 6 and 7, only the frame images selected by the secondary selection using the secondary selection circuitry 302 remain in the storage unit 31 of the cloud server 3. In the first embodiment, in the edge device 1, the frame image selected by the primary selection and the moving image corresponding to the frame image may be sequentially deleted from the oldest data in the FIFO queue. In a case where the frame image remaining in the cloud server 3 is stored together with text information describing the attribute of the object serving as the basis for keeping the frame image, the search becomes easy later.

As described above, by distributing the processing of the primary selection and the secondary selection between the edge device 1 and the cloud server 3, it is possible to reduce the processing load of the edge device 1 having relatively small computational resources. Because only the data selected by the primary selection of the edge device 1 is transmitted to the cloud server 3, it is possible to reduce the amount of communication as compared with a case where all the captured frame images are transmitted to the cloud server 3.

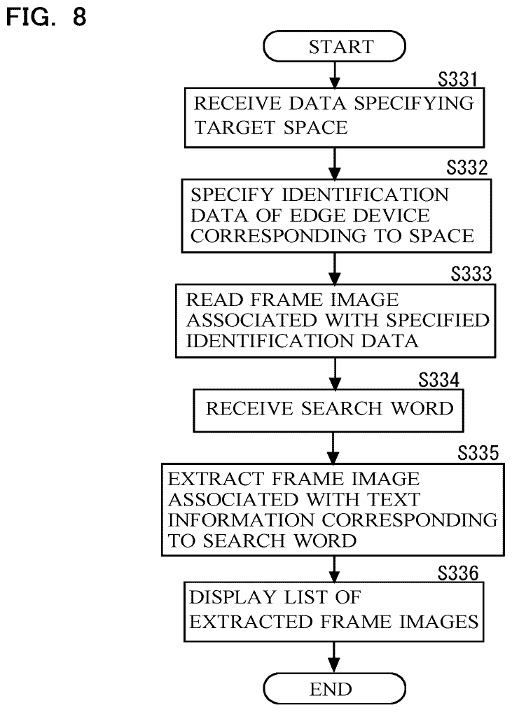

The frame image selected by the second selection and stored in the storage unit 31 of the cloud server 3 can be displayed on the display 43 of the client 4. FIG. 8 is a flowchart illustrating an example of a display control procedure in the image display system 100. When the user accesses the cloud server 3 using the client 4, the processing unit 30 of the cloud server 3 starts the following processing as a selection operation circuitry 303 and an image display control circuitry 304.

The processing unit 30 of the cloud server 3 receives data specifying a target space from the client 4 as the selection operation circuitry 303 (step S331). In step S331, the processing unit 30 receives account data of the user, identification data or a name of the space, and the like. The processing unit 30 may receive the identification data of the camera 2 included in the image information. In step S331, the processing unit 30 may receive a selection from the list of the identification data of the edge devices 1 which the user is allowed to access with the account data used when the user accesses the cloud server 3 through client 4, or the list of the identification data or the names of the spaces corresponding to the above-described allowed edge devices 1.

The processing unit 30 specifies the identification data of the edge device 1 corresponding to the space specified by the received data (step S332), and reads the frame images associated with the specified identification data of the edge device 1 from the storage unit 31 (step S333). In step S333, the continuous frame images may be read as a moving image.

The processing unit 30 receives a search word corresponding to a user's desired object (viewing target) from the client 4 as the selection operation circuitry 303 (step S334). In step S334, the processing unit 30 may cause the client 4 to display a thumbnail list of the frame images read in step S333, and receive selection of a user's desired object through a user selection operation of any one of the thumbnails.

As the image display control circuitry 304, the processing unit 30 extracts a frame image associated with text information corresponding to the search word or a frame image selected from the thumbnail list from the frame images read in step S333 (step S335). The processing unit 30 displays a list of the extracted frame images on the display 43 of the client 4 (step S336), and ends the processing.

In step S336, when the frame images read in step S333 are continuous in time series and are moving images, the processing unit 30 may display a representative frame image as a thumbnail in step S336.

In the processing illustrated in FIG. 8, steps S334 and S335 may be omitted, and a list of the frame images read in step S333 may be displayed in step S336.

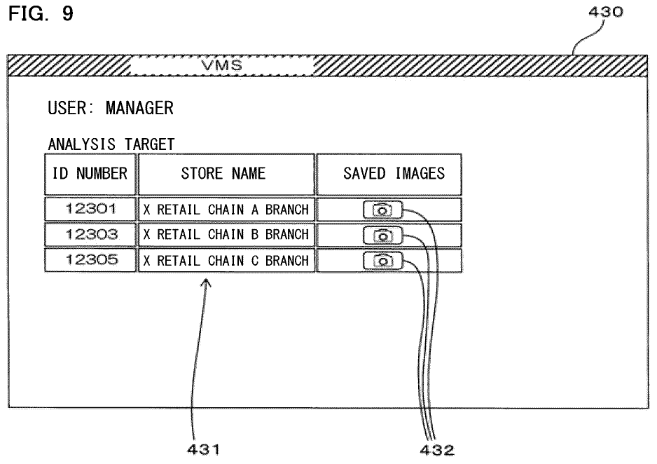

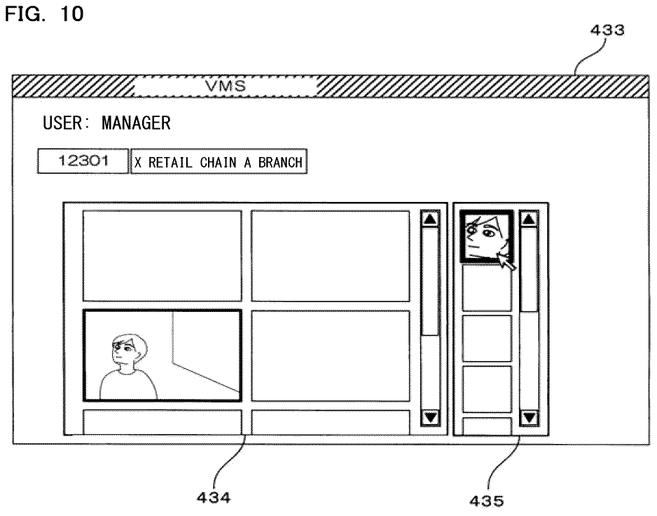

FIGS. 9 and 10 are explanatory diagrams illustrating display examples of images on the client 4. FIGS. 9 and 10 illustrate an example in which a screen provided by the function of the Web server of the cloud server 3 is displayed by the function of the Web browser included in the client program P4 in response to access from the processing unit 40 of the client 4. On the screen 430 illustrated in FIG. 9, a list 431 of spaces permitted to be browsed by the user who operates the client 4 is displayed. The list 431 includes interfaces 432 with links to image display screens 433 each of which displays images saved (stored) for each of the spaces. In the example of FIG. 9, a list 431 of “X retail chain A branch”, “X retail chain B branch”, and “X retail chain C branch” is displayed.

FIG. 10 is a diagram illustrating an example of the image display screen 433. The image display screen 433 illustrated in FIG. 10 is displayed when the interface 432 for the “X retail chain A branch” is selected from the list 431 illustrated in FIG. 9 by the user using the operation unit 44.

The image display screen 433 includes an area 434 displaying a list of frame images stored by being selected by the primary selection circuitry 101 and the secondary selection circuitry 302, and an area 435 displaying a list of object images obtained by extracting regions where user's desired objects are detected in the frame images. In the image display screen 433, when an object image included in the area 435 is selected, the original frame image from which the object image is extracted is highlighted in the area 434. By an operation on an object image by the operation unit 44, a moving image including the original frame image, from which the object image is extracted, may be downloadable from the cloud server 3 to the storage unit 41 of the client 4, or may be temporarily downloadable to a temporary storage medium in the processing unit 40. Here, the process of enabling downloading to the storage unit 41 of the client 4 corresponds to the process performed by the image storage control circuitry in the claims.

According to the image display system 100 of the first embodiment, it is possible to accurately select a frame image in which a user's desired viewing target appears while suppressing a processing load on the edge device 1, and display the selected frame image and a moving image for a predetermined time before and after the selected frame image on the display 43 of the client 4 via the cloud server 3.

### Second Embodiment

In the image display system 100 of the first embodiment, the cloud server 3 once stores (saves) the frame image, which is primarily selected by the edge device 1, by using the function of the cloud side storage circuitry 301. In the second embodiment, by the processing of the secondary selection circuitry 302, the frame image itself in which the user's desired object appears is not left in the storage unit 31, and only the time information of the frame image is left in the storage unit 31.

In the configuration of the image display system 100 of the second embodiment, the hardware configuration of each device is the same as that of the image display system 100 of the first embodiment. Therefore, in the image display system 100 of the second embodiment, the same reference numerals are given to the same components as those of the first embodiment, and detailed description thereof will be omitted.

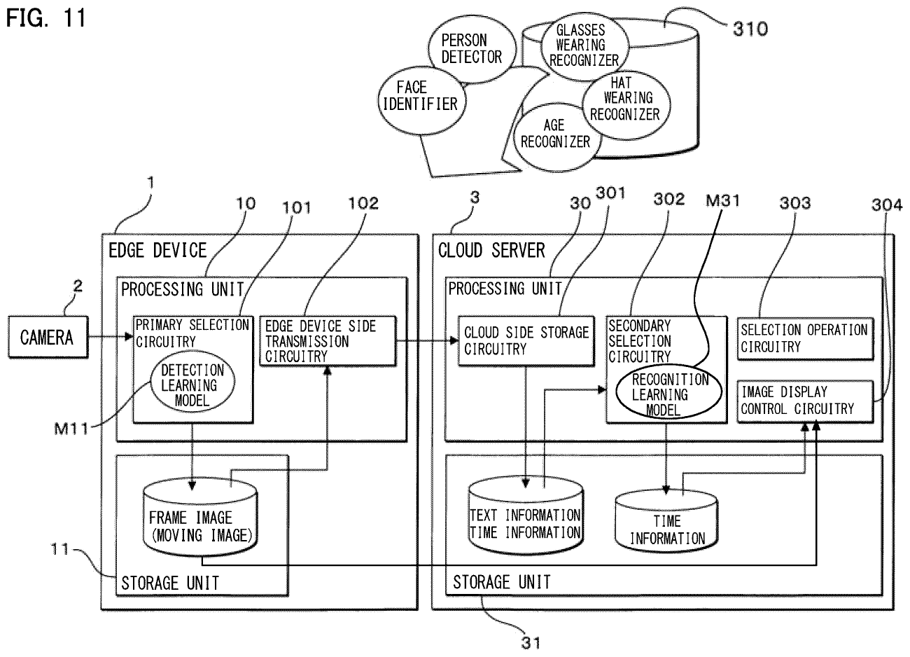

FIG. 11 is a functional block diagram of the image display system 100 according to the second embodiment. Also in the image display system 100 of the second embodiment, similarly to the first embodiment, the processing unit 10 of the edge device 1 functions as the primary selection circuitry 101 and the edge device side transmission circuitry 102, and the processing unit 30 of the cloud server 3 functions as the cloud side storage circuitry 301, the secondary selection circuitry 302, the selection operation circuitry 303, and the image display control circuitry 304.

Also in the second embodiment, the processing unit 10 of the edge device 1 selects a frame image, in which an object is likely to appear, by using the detection learning model M11 as the primary selection circuitry 101. As in the first embodiment, the detection learning model M11 is selected from the database 310 according to the object to be detected and can be used in the detection process. The primary selection circuitry 101 stores the selected frame images in the storage unit 11, and discards frame images that are not selected. The primary selection circuitry 101 stores a moving image for a predetermined time before and after the selected frame image. In a case where the primary selection circuitry 101 selects frame images continuous in time series, the primary selection circuitry 101 may store the frame images as a series of moving images.

Also in the second embodiment, the processing unit 10 of the edge device 1 transmits, as the edge device side transmission circuitry 102, a frame image selected by the function of the primary selection circuitry 101 through the second communication unit 13. In the second embodiment, the edge device side transmission circuitry 102 does not need to transmit a moving image including other frame images before and after a frame image.

In the second embodiment, the cloud side storage circuitry 301 stores the primarily selected frame image transmitted from the edge device 1 in the storage unit 31. The image information corresponding to the primarily selected frame image which is stored in the storage unit 31 may be deleted by a process of a secondary selection circuitry 302 described later.

In the second embodiment, similarly to the first embodiment, the secondary selection circuitry 302 selects a frame image in which a user's desired object appears from frame images stored (saved) in the storage unit 31 using the recognition learning model M31. As in the first embodiment, the recognition learning model M31 is selected from the database 310 according to the object to be detected and can be used in the recognition process. The secondary selection circuitry 302 stores the time information corresponding to the selected frame image in the storage unit 31 in association with the identification data of the edge device 1 of the transmission source, the identification data of the space, or the identification data of the camera 2. The secondary selection circuitry 302 may delete the frame image, for which the secondary selection process has been completed, from the storage unit 31. Thus, it is possible to avoid a state in which frame images captured at various places are accumulated in the cloud server 3 accessible from each client 4.

Also in the second embodiment, the selection operation circuitry 303 performs control to accept, from the operation unit 44 of the client 4, a user's selection operation of image information displayed on the display 43 of the client 4 connected to the cloud server 3 among pieces of image information narrowed down by the secondary selection of the secondary selection circuitry 302.

In the second embodiment, the image display control circuitry 304 causes a moving image including a frame image corresponding to time information selected and stored by the secondary selection of the secondary selection circuitry 302 to be transmitted from the edge device 1 to the client 4 and displayed on the display 43. The image display control circuitry 304 may temporarily acquire a frame image corresponding to time information designated by the user from the client 4 and a moving image including the frame image from the edge device 1, and transmit the frame image and the moving image to the client 4. The image display control circuitry 304 may redirect transmission of a moving image using the edge device 1 as a host to the client 4, while temporarily acquiring from the edge device 1 a frame image corresponding to time information designated by the user from the client 4. When the image display control circuitry 304 makes the edge device 1 directly transmit the moving image to the client 4, it is possible to avoid storing data in the cloud server 3. In this case, the first image display program P1 of the edge device 1 includes a module that realizes a function as a host for video distribution. In the edge device 1, unique identification data (MAC address or the like) of the clients 4 allowed to access the host may be stored as a white list, and a moving image may be streamed or downloaded only to the allowed clients 4. The above-described processing of enabling downloading to the storage unit 41 of the allowed client 4 corresponds to the processing performed by the image storage control circuitry in the claims.

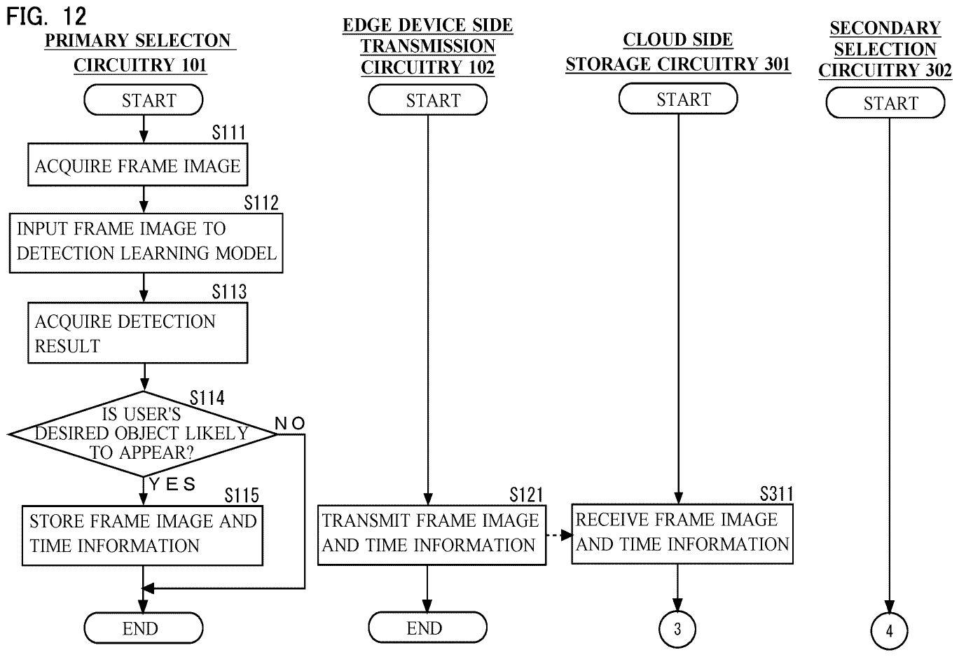

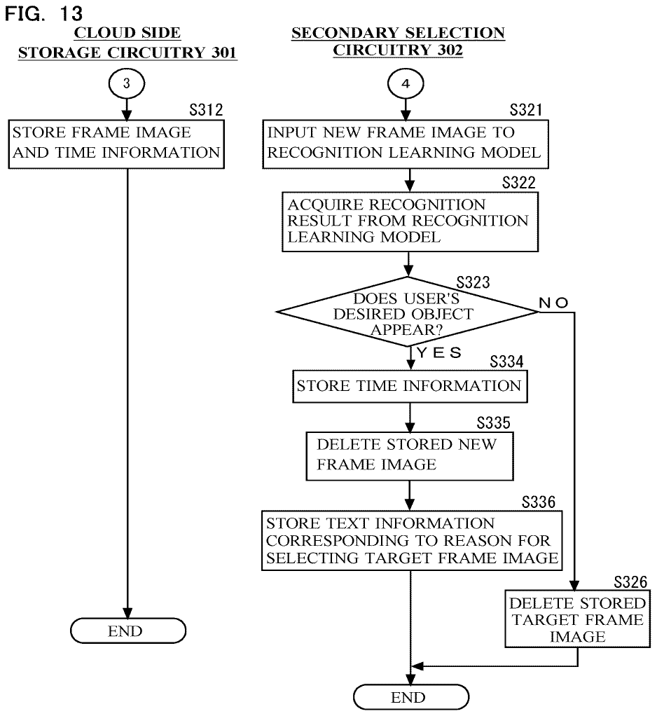

FIGS. 12 and 13 are flowcharts illustrating an example of a processing procedure in the image display system 100 according to the second embodiment. In the processing procedures illustrated in FIGS. 12 and 13, the same step numbers are given to procedures common to the processing procedures illustrated in FIGS. 6 and 7 of the first embodiment, and detailed description thereof will be omitted.

The processing procedures of the primary selection circuitry 101, the edge device side transmission circuitry 102, and the cloud side storage circuitry 301 are the same as the processing procedures illustrated in FIGS. 6 and 7 of the first embodiment. In the second embodiment, when the processing unit 30 of the cloud server 3 determines that the user's desired object appears in the frame image according to the detailed selection criteria in step S323 by the function of the secondary selection circuitry 302 (S323: YES), the processing unit 30 stores time information corresponding to the frame image in the storage unit 31 (step S334). In step S334, the processing unit 30 stores the identification data of the edge device 1 that is the transmission source of the frame image in association with the time information. The processing unit 30 may delete the stored new frame image from the storage unit 31 (step S335).

The processing unit 30 stores the text information corresponding to the attribute recognized by the recognition learning model M31 used for the new frame image in step S321, that is, the text information corresponding to the reason (attribute) for selecting the target frame image in association with the time information (step S336). Because the process of step S336 means storing text information for search, it is unnecessary when text-based search is not accepted in the image display system 100.

When the processing unit 30 determines that the user's desired object does not appear in the frame image (S323: NO), the processing unit 30 deletes the target frame image stored in the storage unit 31 by the cloud side storage circuitry 301 from the storage unit 31 (S326), and ends the process.

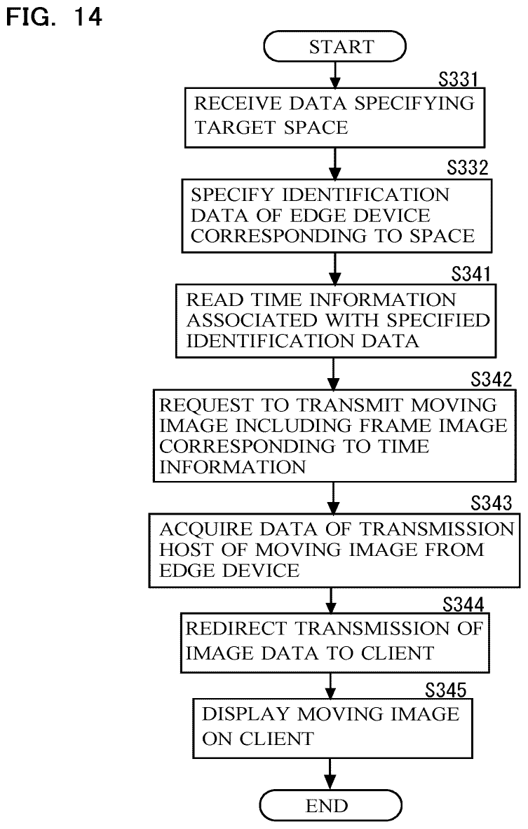

FIG. 14 is a flowchart illustrating an example of a processing procedure by the selection operation circuitry 303 and the image display control circuitry 304 according to the second embodiment. In the processing procedure illustrated in FIG. 14, the same step numbers are given to procedures common to the processing procedure illustrated in FIG. 8 of the first embodiment, and detailed description thereof will be omitted.

As the image display control circuitry 304, the processing unit 30 of the cloud server 3 in the second embodiment specifies the identification data of the edge device 1 corresponding to the target space based on the data received from the client 4 (S332), and reads the time information associated with the specified identification data of the edge device 1 from the storage unit 31 (step S341). The processing unit 30 requests the edge device 1 of the specified identification data to transmit a moving image including a frame image corresponding to the read time information (a moving image for a predetermined time before and after the frame image) from the edge device 1 (step S342). The processing unit 30 acquires data of the transmission host of the moving image from the edge device 1 of the request destination (step S343), redirects transmission of the image data to the client 4 of the access source (step S344), displays the moving image on the client 4 (step S345), and ends the process.

Also in the image display system 100 of the second embodiment, the screen 430 and the image display screen 433 as shown in FIGS. 9 and 10 of the first embodiment are displayed on the client 4, and a list of frame images in which a user's desired viewing target appears can be displayed so as to be selectable from the list. Image information such as a moving image corresponding to the selected frame image may be streamed or downloaded from the edge device 1 to the client 4. Here, the above-described process of enabling downloading to the storage unit 41 of the client 4 corresponds to the process performed by the image storage control circuitry in the claims.

The image display system 100 of the second embodiment prevents the cloud server 3 from storing frame images and moving images as much as possible, and can display a necessary image without storing an image of an object to be captured in each space, particularly, an image of a customer in the cloud server 3. Accordingly, the image display system 100 can make it possible for the user to view a frame image or a moving image in which it is determined that a specific object appears with higher accuracy while considering personal information.

### Third Embodiment

In the image display system 100 of the first embodiment, the cloud server 3 once stores (saves) the frame image, which is selected by the edge device 1, by using the function of the cloud side storage circuitry 301. In the third embodiment, the processing on the cloud server 3 side and the storage unit 31 are distributed to a plurality of server computers. In the third embodiment, as in the second embodiment, the data to be left in the storage unit 31 of the cloud server 3 is not the frame image itself in which the user's desired object appears, but only the time information of the frame image.

In the configuration of the image display system 100 of the third embodiment, the hardware configuration of each device is the same as that of the image display system 100 of the first embodiment. Therefore, in the image display system 100 of the third embodiment, the same reference numerals are given to the same components as those of the first embodiment, and detailed description thereof will be omitted.

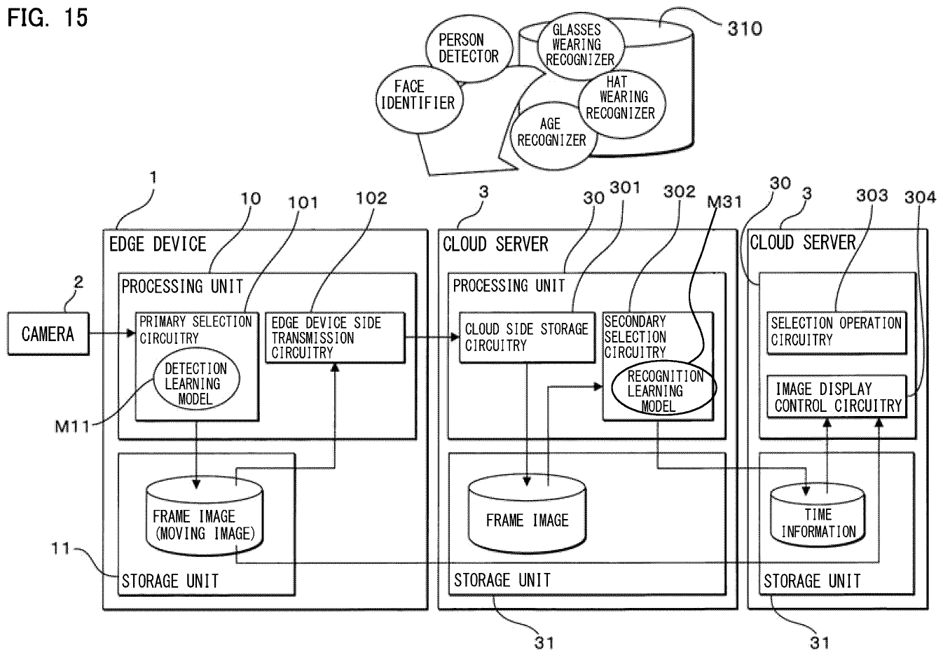

FIG. 15 is a functional block diagram of the image display system 100 according to the third embodiment. In the image display system 100 of the third embodiment, the cloud server 3 is configured by two servers configured by different hardware.

Also in the image display system 100 of the third embodiment, the processing unit 10 of the edge device 1 functions as the primary selection circuitry 101 and the edge device side transmission circuitry 102, the processing unit 30 of the first cloud server 3 functions as the cloud side storage circuitry 301 and the secondary selection circuitry 302, and the processing unit 30 of the second cloud server 3 functions as the image display control circuitry 304.

The function of the edge device 1 in the third embodiment is the same as the function of the edge device 1 in the first and second embodiments.

In the third embodiment, the cloud side storage circuitry 301 functioning by the processing unit 30 of the first cloud server 3 stores the primarily selected frame image transmitted from the edge device 1 in the storage unit 31.

In addition, the secondary selection circuitry 302 functioning by the processing unit 30 of the first cloud server 3 selects a frame image in which a user's desired object appears from the frame images stored (saved) in the storage unit 31 of the first cloud server 3 using the recognition learning model M31. As in the first embodiment, the recognition learning model M31 is selected from the database 310 and can be used in the recognition process. The secondary selection circuitry 302 stores the time information corresponding to the selected frame image in the storage unit 31 of the second cloud server 3 in association with the identification data of the edge device 1 of the transmission source, the identification data of the captured space, or the identification data of the camera 2.

The image display control circuitry 304 functioning by the processing unit 30 of the second cloud server 3 transmits the moving image including the frame image corresponding to the time information selected and saved by the second selection of the second selection circuitry 302 from the edge device 1 to the client 4 and displays the moving image on the display 43. The image display control circuitry 304 may temporarily acquire a frame image corresponding to time information designated by the client 4 and a moving image including the frame image, and transmit the frame image and the moving image to the client 4. The image display control circuitry 304 may redirect transmission of a moving image using the edge device 1 as a host to the client 4, while temporarily acquiring from the edge device 1 a frame image corresponding to time information designated by the user from the client 4. Also in the third embodiment, when the image display control circuitry 304 makes the edge device 1 directly transmit the moving image to the client 4, it is possible to avoid storing data in the cloud server 3. In this case, the first image display program P1 of the edge device 1 of the third embodiment includes a module that realizes a function as a host for video distribution. In the edge device 1, unique identification data (MAC address or the like) of the clients 4 allowed to access the host may be stored as a white list, and a moving image may be streamed or downloaded only to the allowed clients 4. Here, the above-described process of making it possible to download the moving image to the storage unit 41 of the client 4 corresponds to the process performed by the image storage control circuitry in the claims.

As illustrated in FIG. 15, in the third embodiment, the cloud servers 3 are divided into a first cloud server 3 and a second cloud server 3. Then, the frame image is sent to and stored in the first cloud server 3 in the secure environment, but the frame image is not sent to and stored in the storage unit 31 of the second cloud server 3 that exerts the functions of the selection operation circuitry 303 and the image display control circuitry 304, that is, the cloud server 3 in the open environment that receives access from the client 4.Accordingly, it is possible to avoid a state in which frame images captured at various places are stored and accumulated in the cloud server 3 in an open environment accessible from each client 4.

The processing procedure by each function of the image display system 100 of the third embodiment is the same as that of the second embodiment except that the cloud server 3 is configured by two servers. The processing unit 30 of the first cloud server 3 executes the processes (S311 and S312) as the cloud side storage circuitry 301 and the processes (S321 to S323, S326, and S334-S336) as the secondary selection circuitry 302 in the processing procedure illustrated in FIGS. 12 and 13 of the second embodiment. Further, the processing unit 30 of the second cloud server 3 executes the processing procedure illustrated in FIG. 14 of the first embodiment as the selection operation circuitry 303 and the image display control circuitry 304.

Also in the image display system 100 of the third embodiment, the screen 430 and the image display screen 433 as shown in FIGS. 9 and 10 of the first embodiment are displayed on the client 4, and a list of frame images in which a user's desired viewing target appears can be displayed so as to be selectable from the list. The moving image corresponding to the selected frame image may be streamed or downloaded from the edge device 1 to the client 4. Here, the process of making it possible to download the moving image to the storage unit 41 of the client 4 corresponds to the process performed by the image storage control circuitry in the claims.

As described in the third embodiment, the second cloud server 3 accessible from the client 4 stores only the time information without storing the frame image and the moving image, and thus it is possible to display a necessary image without storing an image of a target to be captured in each space, particularly, an image of a customer in the (second) cloud server 3 accessible from the client 4. Accordingly, the image display system 100 can make it possible for the user to view a frame image or a moving image in which it is determined that a specific object appears with higher accuracy while considering personal information.

### Fourth Embodiment

In the image display system 100 of the first embodiment, the cloud server 3 once stores (saves) the frame image, which is selected by the edge device 1, by using the function of the cloud side storage circuitry 301. In the fourth embodiment, the frame image is not transmitted from the edge device 1 to the cloud server 3 side, and therefore the communication load is further reduced. In the cloud server 3 of the fourth embodiment, the data to be left in the storage unit 31 of the cloud server 3 is only the time information corresponding to the frame image in which the user's desired object appears.

In the configuration of the image display system 100 of the fourth embodiment, the hardware configuration of each device is the same as that of the image display system 100 of the first embodiment. Therefore, in the image display system 100 of the fourth embodiment, the same reference numerals are given to the same components as those of the first embodiment, and detailed description thereof will be omitted.

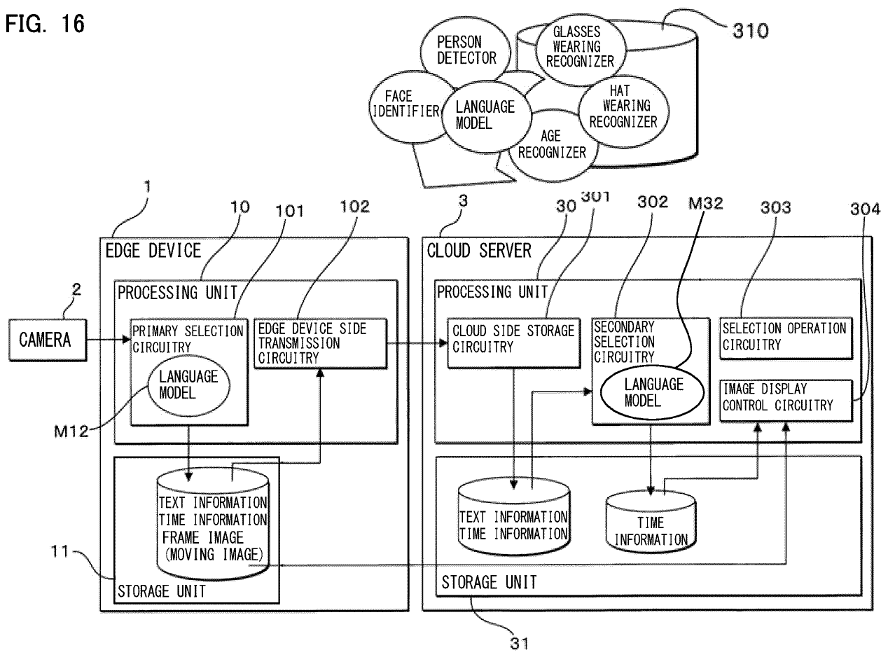

FIG. 16 is a functional block diagram of the image display system 100 according to the fourth embodiment. Also in the image display system 100 of the fourth embodiment, similarly to the first embodiment, the processing unit 10 of the edge device 1 functions as the primary selection circuitry 101 and the edge device side transmission circuitry 102, and the processing unit 30 of the cloud server 3 functions as the cloud side storage circuitry 301, the secondary selection circuitry 302, and the image display control circuitry 304.

In the fourth embodiment, the processing unit 10 of the edge device 1 receives a frame image obtained by the camera 2 through the first communication unit 12 as the primary selection circuitry 101. The primary selection circuitry 101 obtains text information representing a sentence or a word describing an object or a person appearing in the acquired frame image using the language model M12. The language model M12 is a multimodal language model capable of inputting an image or a vision language model (VLM) which is selected from the database 310 and stored in the storage unit 11. Further, a verbalization process using a language model M12 is deployed in the edge device 1. The primary selection circuitry 101 instructs the language model M12 to output a sentence or a word describing a person or an object appearing in the frame image, and obtains the sentence or the word to be output from the language model M12. The processing unit 10 selects a target frame image as the primary selection circuitry 101 when it can be determined that a user's desired object is likely to appear from the obtained sentence or word. The primary selection circuitry 101 may store the selected frame image in the storage unit 11 and discard the unselected frame image. The primary selection circuitry 101 stores a moving image for a predetermined time before and after the selected frame image in the storage unit 11. In a case where frame images continuous in time series are selected, the primary selection circuitry 101 may save the frame images as a series of moving images. In a case where the processing unit 10 cannot detect an object such as a person as the primary selection circuitry 101, the processing unit 10 ends the processing on the target frame image, does not execute the subsequent processing, and executes the processing on the next frame image.

In the fourth embodiment, the edge device side transmission circuitry 102 transmits text information which is image information corresponding to a frame image selected by the primary selection circuitry 101 and time information corresponding to the frame image to the cloud server 3 by the second communication unit 13. At this time, the edge device side transmission circuitry 102 transmits the text information and the time information in association with the identification data of the edge device 1. As in the first embodiment, the time information is information indicating any one of a time, a time stamp, and an elapsed time or count from a specific time which are corresponding to a frame image.

In the fourth embodiment, the cloud side storage circuitry 301 receives text information describing a selected frame image, time information, and identification data of the edge device 1 which are transmitted from the edge device 1 by the edge device side transmission circuitry 102, and stores the text information, the time information, and the identification data in the storage unit 31. The image information may not be transmitted from the edge device 1 to the cloud server 3.

In the fourth embodiment, the secondary selection circuitry 302 uses text information stored in the storage unit 31 by the cloud side storage circuitry 301 to select a frame image, in which a user's desired object appears, in accordance with a detailed selection criterion. The detailed selection criterion is a criterion for more reliably detecting that a user's desired object appears, similarly to the selection criterion used by the secondary selection circuitry 302 in the first embodiment.

The secondary selection circuitry 302 uses the language model M32 for a sentence or a word describing what appears in a frame image stored in the storage unit 31 in association with target time information to select time information indicating a time at which a frame image in which a user's desired object appears was captured, and stores the selected time information in the storage unit 31 together with text information corresponding to the selected time information. The secondary selection circuitry 302 may select time information based on whether a specific word is included in text information stored in the storage unit 31 without using the language model M32. Because the selection criteria for the secondary selections circuitry 302 are more detailed (stricter) than the selection criteria for the primary selections circuitry 101, the text information and the corresponding time information stored in the storage unit 31 have a smaller amount of data than the text information and the corresponding time information which are transmitted from the edge device 1. The secondary selection circuitry 302 may delete text information other than the text information stored by the processing of the secondary selection circuitry 302 among the text information stored by the cloud side storage circuitry 301.

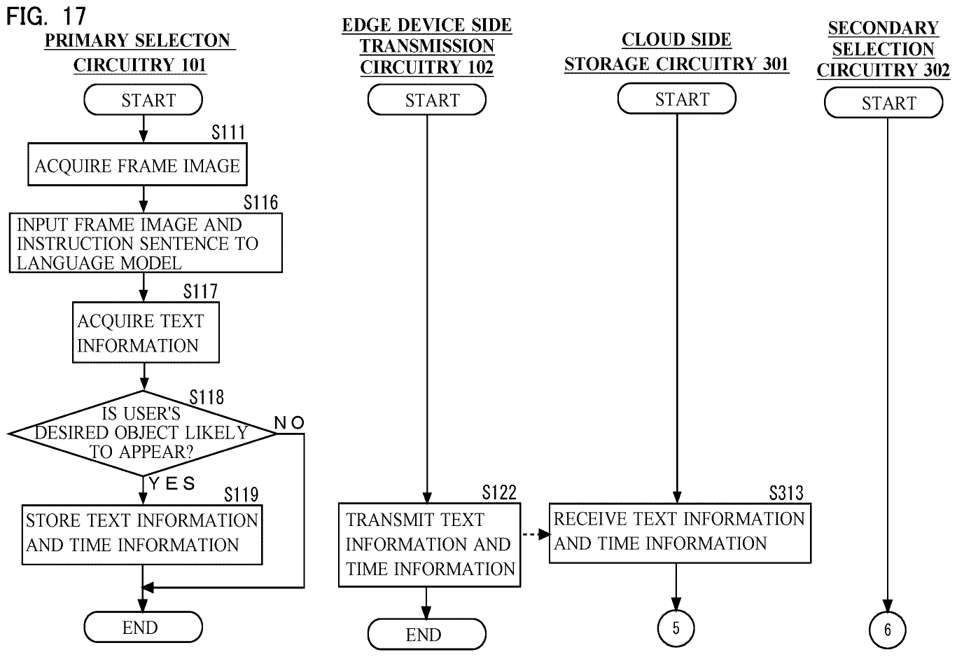

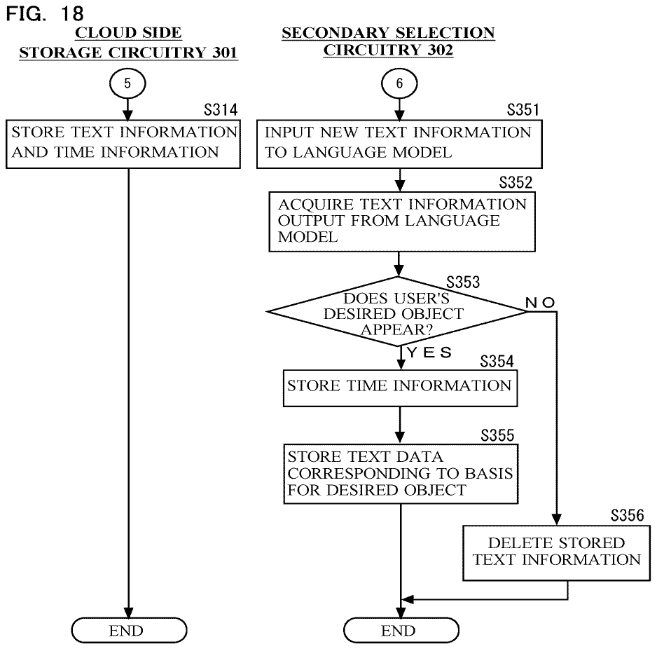

FIGS. 17 and 18 are flowcharts illustrating an example of a processing procedure in the image display system 100 according to the fourth embodiment. In the processing procedures illustrated in FIGS. 17 and 18, the same step numbers are given to procedures common to the processing procedures illustrated in FIGS. 6 and 7 of the first embodiment, and detailed description thereof will be omitted.

The primary selection circuitry 101 inputs the frame image acquired in step S111 to the language model M12 together with the instruction sentence (step S116), and acquires text information such as a sentence or a word to be output from the language model M12 (step S117). The processing unit 10 uses the acquired text information to determine whether or not a user's desired object is likely to appear in the frame image acquired in step S111 (step S118).

When it is determined that a user's desired object is likely to appear in the frame image (S118: YES), the processing unit 10 stores the text information acquired in step S117 and time information indicating the time at which the frame image is captured in the storage unit 11 (step S119). The primary selection circuitry 101 of the processing unit 10 ends the processing on the acquired frame image.

In step S118, when the processing unit 10 does not determine that the user's desired object is likely to appear from the text information acquired in step S117 (S118: NO), the processing unit 10 ends the processing on the acquired frame image. In this case, the acquired text information may not be stored in the storage unit 11.

When new text information is stored in the storage unit 11, the processing unit 10 of the edge device 1 transmits the text information and corresponding time information to the cloud server 3 by the function of the edge device side transmission circuitry 102 (step S122). In step S122, the processing unit 10 transmits also the identification data of the edge device 1.

On the cloud server 3 side, the processing unit 30 receives the text information and the time information transmitted from the edge device 1 by the function of the cloud side storage circuitry 301 (step S313), stores the text information and the time information in the storage unit 31 (step S314), and ends the reception and storage processing. In step S314, the processing unit 30 stores the received identification data of the edge device 1 in association with the text information and the time information.

When new text information is stored in the storage unit 31 by the function of the secondary selection circuitry 302, the processing unit 30 inputs the new text information to the language model M32 (step S351). The processing unit 30 acquires text data corresponding to the explanatory text for the frame image from the language model M32 (step S352). Based on the acquired text data, the processing unit 30 determines whether or not the user's desired object appears in the frame image corresponding to the new text information input to the language model M32 in step S351 according to the detailed selection criterion (step S353).

When the processing unit 30 determines that the user's desired object appears in the frame image corresponding to the new text information according to the detailed (strict) selection criterion (S353: YES), the processing unit 30 stores time information indicating a time at which the frame image is captured in the storage unit 31 (step S354). In step S354, the processing unit 30 also stores the identification data of the edge device 1 stored in association with the time information in step S314 in association with the time information. For the new text information input to the language model M32 in step S351, the processing unit 30 stores the text data corresponding to the attribute, based on which the object in the frame image is recognized as the desired object, in association with the time information (step S355). Because the process of step S355 means storing text data for search, it is unnecessary when text-based search is not accepted in the image display system 100.

When the processing unit 30 determines that the user's desired object does not appear in the frame image corresponding to the new text information (S353: NO), the processing unit 30 may delete the new text information stored in the storage unit 31 by the cloud side storage circuitry 301 from the storage unit 31 (step S356).

According to the processing procedure illustrated in FIGS. 17 and 18, the time information corresponding to the frame image selected by the secondary selection using the secondary selection circuitry 302 is stored in the cloud server 3. When the text data corresponding to the attribute (of the object), based on which the time information is stored, is stored in the cloud server 3 in association with the time information, the search is facilitated later.

As described above, by distributing the processing of the primary selection and the secondary selection between the edge device 1 and the cloud server 3, the processing load of the edge device 1 can be reduced. Because the text information corresponding to the description of the frame image selected by the primary selection of the edge device 1 is transmitted to the cloud server 3, the amount of communication can be significantly reduced as compared with a case where the selected frame image is transmitted to the cloud server 3.

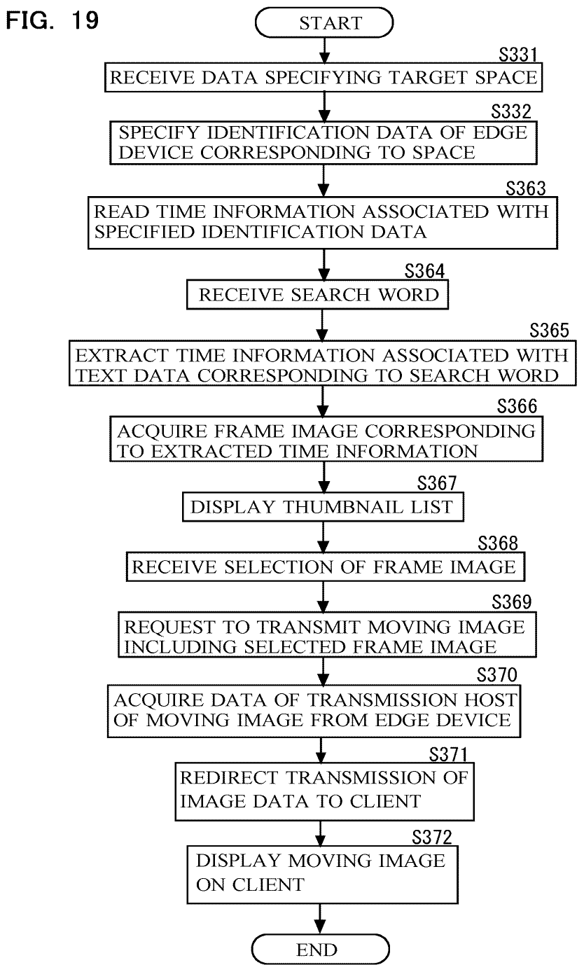

Also in the fourth embodiment, the text information selected by the second selection and stored in the storage unit 31 of the cloud server 3 can be displayed so as to be selectable on the display 43 of the client 4. FIG. 19 is a flowchart illustrating an example of a processing procedure by the selection operation circuitry 303 and the image display control circuitry 304 according to the fourth embodiment. When the user accesses the cloud server 3 using the client 4, the processing unit 30 of the cloud server 3 starts the following processing as the image display control circuitry 304. In the processing procedure illustrated in FIG. 19, the same step numbers are given to procedures common to the processing procedure illustrated in FIG. 8 of the first embodiment, and detailed description thereof will be omitted.

When the processing unit 30 of the cloud server 3 receives the data for specifying the target space from the client 4 as the selection operation circuitry 303 (S331), the processing unit 30 of the cloud server 3 specifies the identification data of the edge device 1 corresponding to the space specified by the received data (S332). The processing unit 30 reads the time information associated with the identification data of the specified edge device 1 from the storage unit 31 (step S363). In step S363, the continuous time information may be read as time information corresponding to a continuous moving image.

The processing unit 30 receives the search word corresponding to the user's desired object from the client 4 by the selection operation circuitry 303 (step S364). The processing unit 30 extracts the time information associated with the text data including the text corresponding to the received search word from the time information read in step S363 (step S365).

The processing unit 30 acquires a frame image corresponding to the extracted time information from the storage unit 11 of the edge device 1 (step S366). As the image display control circuitry 304, the processing unit 30 displays a thumbnail list using the acquired frame image on the client 4 (step S367). The processing unit 30 receives selection of any frame image from the thumbnail list by the selection operation circuitry 303 (step S368).

The processing unit 30 requests the transmission source edge device 1 to transmit the moving image including the selected frame image from the edge device 1 (step S369). As the image display control circuitry 304, the processing unit 30 acquires data of the transmission host of the moving image from the edge device 1 of the request destination (step S370), redirects transmission of the image data to the client 4 of the access source (step S371), displays the moving image on the client 4 (step S372), and ends the process.

The image display system 100 of the fourth embodiment may have a configuration in which the cloud server 3 is divided into two as in the third embodiment.

Also in the image display system 100 of the fourth embodiment, the screen 430 and the image display screen 433 as shown in FIGS. 9 and 10 of the first embodiment are displayed on the client 4, and a list of frame images in which a user's desired viewing target appears can be displayed so as to be selectable from the list. Image information such as a moving image corresponding to the selected frame image may be streamed or downloaded from the edge device 1 to the client 4. Here, the process of making it possible to download the Image information to the storage unit 41 of the client 4 corresponds to the process performed by the image storage control circuitry in the claims.

In the fourth embodiment, the cloud side storage circuitry 301 of the cloud server 3 receives the text information corresponding to the description of the frame image, in which the object may appear, instead of the frame image, receives also the time information of the time when the frame image in which the object may appear is captured, and stores the text information and the time information on the cloud server 3 side. The frame image captured by the edge device 1 is not transmitted to the cloud server 3 even temporarily. Because the size of text information of a sentence or a word describing what appears in the frame image is overwhelmingly small as compared with the size of a frame image, the communication amount of data to be transmitted from the edge device 1 to the cloud server 3 can be suppressed. In addition, because the frame image and the moving image including the frame image are not transmitted from the edge device 1 to the cloud server 3, it is possible to provide the privacy-aware image display system 100.

These and other modifications will become obvious, evident or apparent to those ordinarily skilled in the art, who have read the description. Accordingly, the appended claims should be interpreted to cover all modifications and variations which fall within the spirit and scope of the present invention.

1. An image display system comprising:
a primary selection circuitry configured to perform, on an edge device side, a primary selection of a frame image, which is a process of detecting a user's desired viewing target from frame images input from a camera in accordance with a rough selection criterion to select a frame image in which the user's desired viewing target is likely to appear;
an edge device side transmission circuitry configured to transmit the frame image selected by the primary selection circuitry or image information, which is information corresponding to the frame image selected by the primary selection circuitry, from the edge device side to a cloud side;
a cloud side storage circuitry configured to store, on the cloud side, the frame image or the image information transmitted by the edge device side transmission circuitry;
a secondary selection circuitry configured to perform, on the cloud side, a secondary selection of a frame image, which is a process of selecting a frame image, in which the user's desired viewing target appears, in accordance with a detailed selection criterion by using the frame images or the image information stored in the cloud side storage circuitry; and
an image display control circuitry configured to perform, on the cloud side, control such that an image, in which the user's desired viewing target appears, is displayed on a display on the cloud side by using the frame image selected by the secondary selection in the secondary selection circuitry or time information corresponding to the frame image selected by the secondary selection.

2. The image display system according to claim 1,
wherein the primary selection circuitry outputs, as a result of the primary selection, text information related to the frame image in which the user's desired viewing target is likely to appear.

3. The image display system according to claim 2,
wherein the edge device side transmission circuitry transmits, to the cloud side, text information related to the frame image in which the user's desired viewing target is likely to appear and time information at which the frame image in which the user's desired viewing target is likely to appear is captured.

4. The image display system according to claim 2,
wherein the image information to be transmitted by the edge device side transmission circuitry and stored in the cloud side storage circuitry is the text information output by the primary selection circuitry, and the secondary selection circuitry performs the secondary selection of the frame image using the text information.

5. The image display system according to claim 3,
wherein the image information to be transmitted by the edge device side transmission circuitry and stored in the cloud side storage circuitry is the text information output by the primary selection circuitry, and the secondary selection circuitry performs the secondary selection of the frame image using the text information.

6. The image display system according to claim 1,
wherein the image display control circuitry performs control so as to display, on the display on the cloud side, a moving image in which the user's desired viewing target appears, using the frame image selected by the secondary selection in the secondary selection circuitry or the time information corresponding to the frame image selected by the secondary selection.

7. The image display system according to claim 6,
wherein the image display control circuitry uses a frame image selected by the secondary selection in the secondary selection circuitry or the time information corresponding to the frame image selected by the secondary selection to read the moving image in which the user's desired viewing target appears from the storage device on the edge device side and performs control so as to display the moving image on the display on the cloud side.

8. The image display system according to claim 1, further comprising:
a selection operation circuitry configured for a user to perform a selection operation of a desirable image from the images displayed on the display on the cloud side; and
an image storage control circuitry configured to perform control to read the desirable image selected by the user using the selection operation circuitry from the storage device on the edge device side and store the desirable image in a storage device of a device other than the edge device.

9. The image display system according to claim 1,
wherein the secondary selection circuitry performs the secondary selection of the frame image by using VLM (vision language model) or LLM (large language model).

10. The image display system according to claim 2,
wherein the secondary selection circuitry performs the secondary selection of the frame image by using VLM (vision language model) or LLM (large language model).

11. The image display system according to claim 3,
wherein the secondary selection circuitry performs the secondary selection of the frame image by using VLM (vision language model) or LLM (large language model).

12. A non-transitory computer readable recording medium for recording an image display program to cause a computer to perform a process including the steps of:
performing, on an edge device side, a primary selection of a frame image, which is a process of detecting a user's desired viewing target from frame images input from a camera in accordance with a rough selection criterion to select a frame image in which the user's desired viewing target is likely to appear;
transmitting the frame image selected by the primary selection or image information, which is information corresponding to the frame image selected by the primary selection, from the edge device side to a cloud side;
storing, on the cloud side, the frame image or the image information transmitted from the edge device side;
performing, on the cloud side, a secondary selection of a frame image, which is a process of selecting a frame image, in which the user's desired viewing target appears, in accordance with a detailed selection criterion by using the frame image or the image information stored on the cloud side; and
performing, on the cloud side, control such that an image, in which the user's desired viewing target appears, is displayed on a display on the cloud side by using the frame image selected by the secondary selection or time information corresponding to the frame image selected by the secondary selection.
